(19) United States
(12) Patent Application Publication
(10) Pub. No.: US 2026/0339643 A1
(43) Pub. Date: Oct. 29, 2026

(54) UPGRADE INSTALLATION METHOD AND COMPUTER READABLE STORAGE MEDIUM

(71) Applicant: SHENZHEN ZOLON TECHNOLOGY CO., LTD., Shenzhen (CN)

(72) Inventors: Jun FAN, Shenzhen (CN); Zhihao WANG, Shenzhen (CN)

(21) Appl. No.: 19/124,144

(22) PCT Filed: Jul. 27, 2023
(86) PCT No.: PCT/CN2023/109687

§ 371 Date: Apr. 24, 2025

(30) Foreign Application Priority Data
Oct. 26, 2022 (CN) 202211324179.7

(51) Int. Cl. G06F 8/65; G06F 8/61

(52) U.S. Cl. CPC G06F 8/65; G06F 8/61

(57) ABSTRACT

An upgrade installation method includes: obtaining an installation instruction of a signature application; when it is determined that the installation instruction is an upgrade installation instruction, transmitting an upgrade download request to a service platform, which causes the service platform to transmit a differential package and current signature information, which correspond to a second version of the signature application, to the terminal device; obtaining an original signature installation package of a first version of the signature application; restoring the original signature installation package to obtain the original installation package; generating a corresponding upgrade signature installation package based on the original installation package, the differential package, and current signature information; when it is determined that the upgrade signature installation package is verified successfully, upgrading and installing the signature application according to the upgrade signature installation package, thus the signature application is upgraded from the first version to the second version.

The present disclosure claims the priority of the Chinese invention patent disclosure with the invention name “UPGRADE INSTALLATION METHOD AND APPARATUS, SYSTEM, ELECTRONIC DEVICE, AND STORAGE MEDIUM” submitted to the China Patent Office on Oct. 26, 2022, application No. 202211324179.7, and the whole content of which is hereby incorporated by reference.

### TECHNICAL FIELD

The present application relates to the field of data process technology, in particular relates to an upgrade installation method and a computer readable storage medium.

### BACKGROUND

As quickly development in internet and mobile terminal technology, requirements of users are also improved. For satisfying with the diversity of the users requirements, a lot user-friendly applications have arisen, such as, various of signature applications. While a process of installing or upgrading a signature application, the signature application executes an installation of installing or upgrading after a signature information of the signature application is verified successfully.

However, while the process of upgrading of the signature application, when a new signature information of a new version of the signature application to-be-installed and an old signature information of an old installed version of the signature application are existed at the same time, the verifying of the signature application is failed, and the installation of upgrading of the signature application is failed. For upgrading and installing the signature application successfully, users need to manually delete the old installed version of the signature application for deleting the old signature information of the old installed version. Thus, an efficiency of the installation of upgrading of the signature application is low.

### BRIEF DESCRIPTION OF THE DRAWINGS

To describe technical solutions in embodiments of this application more clearly, the following briefly describes the accompanying drawings for describing embodiments. It is clear that the accompanying drawings in the following descriptions show some embodiments of this application, and a person of ordinary skill in the art may still derive other drawings from these accompanying drawings without creative efforts.

FIG. 1 is a schematic diagram of a scenario of an upgrade installation system according to the present application.

FIG. 2 is a flowchart of an embodiment of an upgrade installation method according to the present application.

FIG. 3 is a flowchart of another embodiment of an upgrade installation method according to the present application.

FIG. 4 is a structural block diagram of an embodiment of an upgrade installation apparatus according to the present application.

FIG. 5 is a structural block diagram of another embodiment of an upgrade installation apparatus according to the present application.

FIG. 6 is a function block diagram of an embodiment of an electronic device according to the present application.

FIG. 7 is a structural block diagram of a computer readable storage medium according to the present application, which is configured to save or carry program codes for implementing the upgrade installation method according to the present application.

FIG. 8 a structural block diagram of a computer program product according to the present application, which is configured to save or carry program codes for implementing the upgrade installation method according to the present application.

### DETAILED DESCRIPTION

To make the invention objectives, features, and advantages of this application clearer and more comprehensible, the following clearly describes the technical solutions in the embodiments of this application. Apparently, the embodiments described in the following are merely some rather than all of the embodiments of this application. All other embodiments obtained by persons of ordinary skill in the art without creative efforts fall within the protection scope of this application.

It should be understood that the term “include” indicates the presence of the described features, wholes, steps, operations, elements, and/or components, but does not preclude the presence or addition of one or more other features, wholes, steps, operations, elements, components, and/or collections thereof.

It should be understood that the terms used in embodiments of this application are merely for the purpose of illustrating specific embodiments, and are not intended to limit the present invention. The terms “a”, “the” and “this” of singular forms used in descriptions of the specification and the appended claims of this application are also intended to include plural forms, unless otherwise specified in the context clearly.

It should also be understood that the terms of “and/or” used in the specification and the appended claims of the present application refers to any combination of one or more of associated items and all possible combinations, and includes such combinations.

The term “if” may be interpreted as “when” or “once” or “in response to determining” or “in response to monitoring” depending on the context. Similarly, the phrase “if it is determined” or “if [a described condition or event] is monitored” may be interpreted, depending on the context, to mean “once determined” or “in response to determining” or “once [the described condition or event] is monitored” or “in response to monitoring [the described condition or event]”.

In addition, in the terms “first”, “second”, “third”, and the like are merely used for distinguishing descriptions, but cannot be understood as indicating or implying relative importance.

The following clearly describes the technical solutions in embodiments of this application with reference to the accompanying drawings in embodiments of this application.

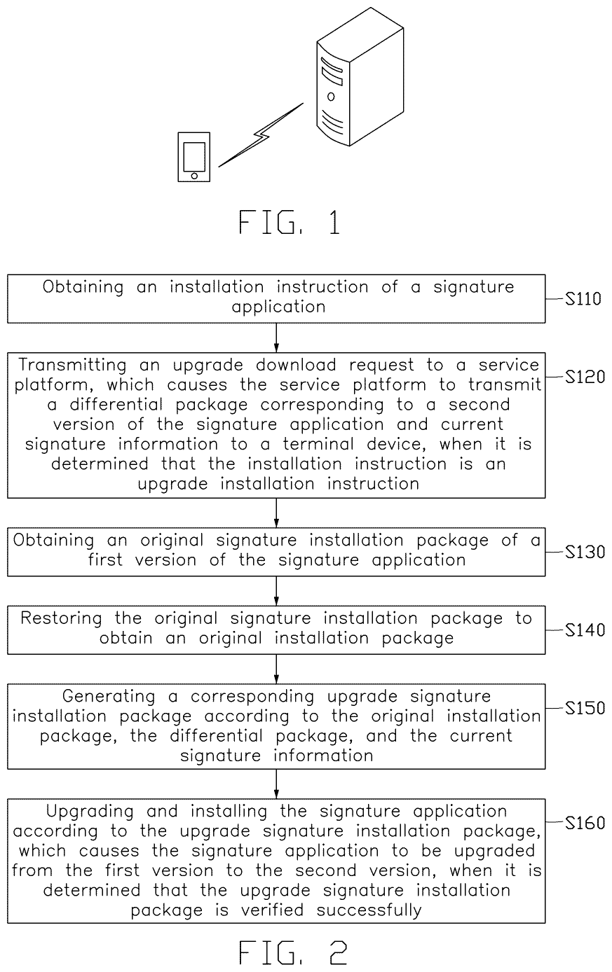

Referring to FIG. 1, FIG. 1 shows a scenario of an upgrade installation system according to the present application, which includes a terminal device 100 and a service platform 200. The terminal device 100 is communicatively connected with the service platform 200, and performs a data interaction with the service platform 200.

The terminal device 100 may be configured to install applications (for example, signature applications). The terminal device 100 may downloaded and installed a required application from the service platform 200. The terminal device 100 may be a mobile terminal device (for example, a mobile phone, a personal digital assistance (PDA), a tablet personal computer (Tablet PC), a notebook, a smart watch, and a smart band, and so on) and a fixed terminal device (such as a desktop computer or a smart panel, and so on), and the like, which is not limited in this application.

The service platform 200 may be configured to receive the applications uploaded by developers, and manage properties of the applications, such as a type, a property, and an installation signature verification, and the like. The service platform 200 may be an independent physical server platform, also may be a server cluster or a distributed system platform, which is constituted by a plurality of physical servers, or may be a cloud server providing basic cloud computing services, such as cloud servers, cloud databases, cloud computing, could functions, cloud storage, network services, cloud communications, middleware services, domain name services, security services, and content delivery network (CDN), and big data and artificial intelligence platforms.

In some embodiments, the terminal device 100 may connect with the service platform 200 using a network, and perform a data interaction with the service platform 200.

The network may be one of a ZigBee network, a Bluetooth network (BT), a Wireless Fidelity (Wi-Fi) network, a Thread network, a long range radio (LoRa) network, a low-power Wide-Area network (LPWAN), an infrared network, a narrow band internet of things (NB-IoT), a controller area network (CAN), a digital living network alliance (DLNA), a wide area network (WAN), a local area network (LAN), a metropolitan area network (MAN), or a wireless personal area network (WPAN), which is not limited in this application.

In one scenario, when obtaining an installation instruction of a signature application, the terminal device 100 transmits a download request to the service platform 200 through the network, the service platform 200 receives and responses to the download request for transmitting an installation package and signature information corresponding to the signature application to the terminal device 100 through the network. The terminal device 100 receives and response to the installation package and the signature information for verifying the signature information. When the signature information is verified successfully, the terminal device 100 installs the signature application based on the installation package.

When the developer uploads a signature to the service platform, the service platform may invoke a software development kit (SDK) corresponding to a SDK interface supported by the signature application. The SDK computes abstract information of the signature application, and returns the abstract information to the service platform. The service platform receives the abstract information returned by the SDK, and transmits the abstract information to an application developer server. The application developer server receives and responses to the abstract information. The application developer server computes a Hash value corresponding to the abstract information based on a pre-stored private key, obtains the signature information corresponding to the signature application, and transmits the signature information to the service platform. The service platform receives the signature information returned by the application developer server, and stores the signature information.

Referring to FIG. 2, FIG. 2 shows an embodiment of an upgrade installation method of the present application. In a detailed embodiment, the upgrade installation method is used in the terminal device 100 of the upgrade installation system as shown in FIG. 1. The following describes the upgrade installation method of FIG. 2 in detail by using the terminal device 100 as an example. The upgrade installation method may include the following blocks S110-S160.

In block S110, the installation instruction of the signature application is obtained.

In one embodiment, when the signature application is required to be installed by an user, the corresponding installation instruction is transmitted to the terminal device, and the terminal device receives the installation instruction transmitted by the user.

In some embodiments, the terminal device may detect operations of the user. While determining an instruction of installation of the signature application being inputted by the user according to the detected operations of the user, the installation instruction of the signature application is determined to be detected. For example, while the user requires the signature application to be installed, the user may execute a touch operation on an operation panel of the terminal device. The terminal device responses to the touch operation of the user and identifies the touch operation. When identifying the touch operation to be an operation of installing the signature application, the installation instruction of the signature application is determined to be detected.

In some embodiments, the terminal device may set with a voice identification module. While the user requires the signature application to be installed, the user may send voice information in a voice collection range of the voice identification module. The voice identification module collects the voice generated by the user, and executes a voice identification of the collected voice. When identifying the key words, which indicates an installation of the signature application, in an identification result based on the identification result of the voice identification, such as “installing the signature application A”, or “install” and “signature application A”, and the like, the installation instruction of the signature application is determined to be detected.

For example, when the voice information sent by the user is “the signature application A is required to be installed”, the voice identification module identifies the voice information of “the signature application is required to be installed” to obtain the identification result with the key words “the signature application A” and the key word “install”, it is determined that the terminal device detects the installation instruction of the signature application.

In some embodiments, the signature application may be an installed application in the terminal device, and may be an uninstalled application in the terminal device. Therefore, the installation instruction may include an upgrade installation instruction (which represents the terminal device have installed the signature application) and a non-upgrade installation instruction (which represents the terminal device have not installed the signature application).

After obtaining the installation instruction of the signature application, the terminal device may obtain a first application identifier set corresponding to applications installed in the terminal device, and determine that whether the installation instruction is the upgrade installation instruction according to a second application identifier corresponding to the signature application and the obtained first application identifier set. The first application identifier set is a set of the identifiers of the installed applications in the terminal device.

When the second identifier is included in the first application identifier set, it is determined that the installation instruction is the upgrade installation instruction. When the second identifier is not included in the first application identifier set, it is determined that the installation instruction is a non-upgrade installation instruction.

In one application scenario, the applications installed in the terminal device includes an application A, an application B, an application C, an application D, and an application E, and so on. The first application identifier set is {A, B, C, D, E}. When the signature application is the application A, the second application identifier is A, the second application identifier is included in the first application identifier set, which is {A, B, C, D, E}, thus it is determined that the installation instruction is the upgrade installation instruction. When the signature application is an application F, the second identifier is F, the second identifier is not included in the first application identifier set, which is {A, B, C, D, E}, thus it is determined that the installation instruction is the non-upgrade installation instruction. Types of the first application identifier set and the second application identifier are not limited, which may be set according to actual requirements.

In block S120, while it is determined that the installation instruction is the upgrade installation instructions, the upgrade download request is transmitted to the service platform, which causes the service platform to transmit a differential package and the current signature information, which correspond to the second version of the signature application, to the terminal device based on the upgrade download request.

In one embodiment, the service platform pre-stores a current installation package and the current signature information, which correspond to the second version of the signature application. The current signature information is configured to verify the second version of the signature application. The current installation package is configured to install the second version of the signature application while the current signature information has verified the second version of the signature application successfully. The terminal device has been installed with the first version of the signature application. The first version is lower than the second version, which represents that the second version is a to-be-upgraded version of the signature application.

While it is determined that the installation instruction is the upgrade installation instructions, the upgrade download request is transmitted to the service platform, the service platform receives and responses to the upgrade download request for transmitting the differential package and the current signature information, which correspond to the second version of the signature application, to the terminal device. The terminal device receives the differential package and the current signature information. The differential package is a difference data package between a current installation package corresponding to the second version of the signature application and an original installation package corresponding to the first version of the signature application installed in the terminal device.

In detail, when the second application identifier of the signature application is included in the first application identifier set of the applications installed in the terminal device, the terminal device determines that the installation instruction is the upgrade installation instruction and transmits the upgrade download request to the service platform through a predefined application program interface (API). The service platform receives and responses to the upgrade download request for transmitting the differential package and the current signature information, which correspond to the second version of the signature application, to the terminal device. The terminal device receives the differential package and the current signature information transmitted by the service platform. The predefined API may be a Hyper Text Transfer Protocol (HTTP) interface or a Web Service interface, and so on, which is not intended to limit.

In some embodiments, the predefined API interface is the HTTP interface, the upgrade download request is a first upgrade download request. When the second application identifier of the signature application is included in the first application identifier set of the installed application in the terminal device, the terminal device determines that the installation instruction is the upgrade installation instruction, and transmits the first upgrade download request to the service platform through the HTTP interface. The service platform receives and responses to the first upgrade download request for transmitting the differential package and the current signature information, which correspond to the second version of the signature application, to the terminal device through the HTTP interface. The terminal device receives the differential package and the current signature information transmitted by the service platform.

In some embodiments, the predefined API is the Web Service interface, the upgrade download request is a second upgrade download request. When the second application identifier of the signature application is included in the first application identifier set of the installed application in the terminal device, the terminal device determines that the installation instruction is the upgrade installation instruction, and transmits the second upgrade download request to the service platform through the Web Service interface. The service platform receives and responses to the second upgrade download request for transmitting the differential package and the current signature information, which correspond to the second version of the signature application, to the terminal device through the Web Service interface. The terminal device receives the differential package and the current signature information transmitted by the service platform.

In block S130, an original signature installation package of the first version of the signature application is obtained.

In one embodiment, the terminal device may obtain the original signature installation package of the first version of the signature application. The original signature installation package includes original signature information and the original installation package. The original signature information may be configured to verify the first version of the signature application. The original installation package may be configured to install the first version of the signature application while the original signature information has been verified the first version of the signature application successfully.

In some embodiments, the terminal device includes a local memory. The local storage stores the original signature installation package of the first version of the signature application installed in the terminal device. The terminal device may read the original signature installation package of the installed first version of the signature application from the local memory.

In some embodiments, the service platform includes a platform memory. The platform storage stores the original signature installation package of the first version of the signature application installed in the terminal device. The terminal device may transmit an acquiring instruction to the service platform through the network. The service platform receives and response to the requiring instruction for reading the original signature installation package of the first version of the signature application installed in the terminal device from the platform storage. The service platform transmits the original signature installation package to the terminal device through the network. The terminal device receives the original signature installation package returned by the service platform.

In block S140, the original signature installation package is restored to obtain the original installation package.

In one embodiment, after obtaining the original signature installation package of the first version of the signature application, the terminal device may restore the original signature installation package to obtain the original installation package.

In detail, after obtaining the original signature installation package of the first version of the signature application, the terminal device may analysis the original signature installation package to obtain the original installation package and the original signature information and delete the original signature information.

In block S150, a corresponding upgrade signature installation package is generated based on the original installation package, the differential package, and current signature information.

In one embodiment, after restoring the original signature installation package to obtain the original installation package, the terminal device generates the corresponding upgrade signature installation package based on the original installation package, the differential package, and current signature information.

In detail, after restoring the original signature installation package to obtain the original installation package, the terminal device composites the original installation package and the differential package to obtain an upgrade installation package, and performs a package assembly on the upgrade installation package and the current signature information to obtain the upgrade signature installation package.

In some embodiments, when generating the corresponding upgrade signature installation package based on the original installation package, the differential package, and current signature information, the terminal device determines whether the upgrade signature installation package has been verified successfully based on the current signature information.

In detail, the application developer server corresponding to the signature application pre-stores the private key. The terminal device pre-stores a public key corresponding to the private key. After generating the corresponding upgrade signature installation package based on the original installation package, the differential package, and current signature information, the terminal device verifies the current signature information based on the pre-stored public key to obtain a verification result. The terminal device determines whether the upgrade signature installation package is verified successfully based on the verification result. The verification result includes a verification success result and a verification failure result.

When the verification success result is obtained, it is determined that the upgrade signature installation package is verified successfully. When the verification failure result is obtained, it is determined that the upgrade signature installation package is verified unsuccessfully.

In block S160, when it is determined that the upgrade signature installation package is verified successfully, the signature application is upgraded and installed according to the upgrade signature installation package, which cause the signature application to be upgraded from the first version to the second version.

In one embodiment, when it is determined that the upgrade signature installation package is verified successfully, the terminal device may upgrade and install the signature application according to the upgrade signature installation package, which cause the signature application to be upgraded from the first version to the second version, this implements the generation of the upgrade signature installation package according to the original installation package obtained by restoring the original signature package corresponding to the first version, the differential package corresponding to the second version, and the current signature information corresponding to the second version, while it is determined the installation instruction is the upgrade installation instruction, and the signature application is upgraded and installed from the first version into the second version according to the upgrade signature installation package while the upgrade signature installation package is verified successfully, there is no need to delete the original signature information manually by the users, an efficiency of the installation of upgrading of the signature application is improved.

In some embodiments, when the second identifier of the signature application is not included in the first application identifier set of the applications installed in the terminal device, it represents that the terminal device does not install the signature application, the terminal device may be determined that the installation instruction is the non-upgrade installation instruction, and transmit a complete download request to the service platform. The service platform receives and responses to the complete download request for transmitting a current installation package and the current signature information to the terminal device. The terminal device receives the current installation package transmitted by the service platform and the current signature information. The terminal device performs a package assembly on the current installation package and the current signature information to obtain the complete signature installation package. The terminal device determines whether the complete signature installation package is verified successfully according to the current signature information. When the complete signature installation package is verified successfully, the terminal device installs the second version of the signature application according to the complete signature installation package, thus a complete installation process of the signature application is achieved, and an installation experience of installing the signature application by the user is improved.

The solution provided by the present embodiment, the installation instruction of the signature application is obtained, while the installation instruction is the upgrade installation instruction, the upgrade download request is transmitted to the service platform, which causes the service platform to transmit the differential package and the current signature information, which correspond to the second version of the signature application, to the terminal device, according to the upgrade download request. The differential package is the difference data package between the current installation package corresponding to the second version of the signature application and the original installation package corresponding to the first version of the signature application installed in the terminal device. The first version is lower than the second version. The original signature installation package of the first version of the signature application is obtained. The original signature installation package includes the original signature information and the original signature installation package. The original signature installation package is restored to obtain the original installation package. The corresponding upgrade signature installation package is generated based on the original installation package, the differential package, and current signature information. When it is determined that the upgrade signature installation package is verified successfully, the signature application is upgraded and installed according to the upgrade signature installation package, thus the signature application is upgraded from the first version to the second version. This implements the generation of the upgrade signature installation package according to the original installation package obtained by restoring the original signature package corresponding to the first version, the differential package corresponding to the second version, and the current signature information corresponding to the second version while it is determined the installation instruction is the upgrade installation instruction. The signature application is upgraded and installed from the first version into the second version according to the upgrade signature installation package while the upgrade signature installation package is verified successfully. There is no need to delete the original signature information manually by the users, an efficiency of the installation of upgrading of the signature application is improved.

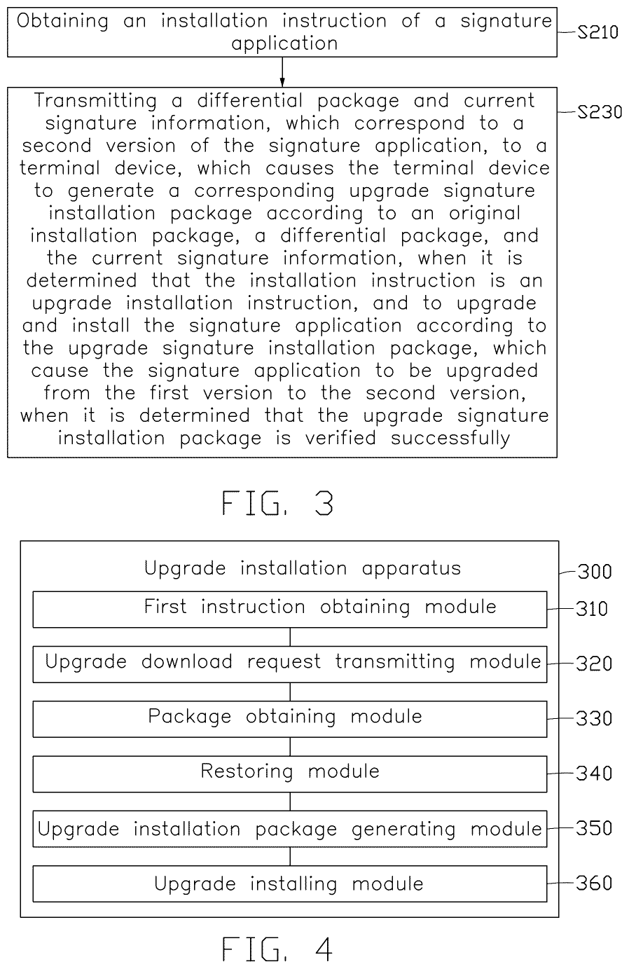

Referring to FIG. 3, FIG. 3 shows another embodiment of an upgrade installation method of the present application. In a detail embodiment, the upgrade installation method is used in the service platform 200 of the upgrade installation system as shown in FIG. 1. The following describes the upgrade installation method of FIG. 3 in detail by using the service platform 200 as an example. The upgrade installation method may include the following blocks S210-S230.

In block S210, the installation instruction of the signature application is obtained.

In one embodiment, when the signature application is required to be installed by an user, the installation instruction is transmitted to the service platform, and the service platform receives the installation instruction transmitted by the user.

In some embodiments, while the user requires to install the signature application in the terminal device, the corresponding installation instruction is transmitted to the service platform, the service platform receives the installation instruction transmitted by the users.

In some embodiments, the upgrading installation system also may include a voice identification module. The voice identification module is connected to the service platform through the network, and executes a data interaction with the service platform through the network. The voice identification module is configured to collect voice information generated by the user and transmit the collected voice information to the service platform through the network.

While the user requires to install the signature application in the terminal device, the user may generate the voice information in a voice collection range of the voice identification module. The voice identification module collects the voice generated by the user, executes a voice identification of the collected voice. When identifying the key words, which indicate an installation of the signature application, in an identification result based on the identification result of the voice identification, such as “installing the signature application A”, or “install” and “signature application A”, and the like, the installation instruction of the signature application is determined to be detected.

For example, when the voice information generated by the user is “the signature application A is required to be installed”, the voice identification module identifies the voice information of “the signature application is required to be installed” to obtain the identification result with the key words “the signature application A” and the key word “install”, it is determined that the service platform detects the installation instruction of the signature application.

In some embodiments, the signature application may be an installed application in the terminal device, and may be an uninstalled application in the terminal device. Therefore, the installation instruction may include an upgrade installation instruction (which represents the terminal device have installed the signature application) and a non-upgrade installation instruction (which represents the terminal device have not installed the signature application).

After obtaining the installation instruction of the signature application, the service platform may obtain a first application identifier set corresponding to the installed applications in the terminal device, and determines that whether the installation instruction is the upgrade installation instruction according to a second application identifier corresponding to the signature application and the obtained first application identifier set. The first application identifier set is a set of the identifiers of the installed applications in the terminal device.

When the second identifier is included in the first application identifier set, it is determined that the installation instruction is the upgrade installation instruction. When the second identifier is not included in the first application identifier set, it is determined that the installation instruction is a non-upgrade installation instruction, which represents that the terminal device has not installed the first version of the signature application.

In block S230, while the installation instruction is the upgrade installation instruction, a differential package and the current signature information, which correspond to a second version of the signature application, are transmitted to the terminal device, which causes the terminal device to generate a corresponding upgrade signature installation package according to an original installation package, the differential package, and the current signature information, to upgrade and install the signature application according to the upgrade signature installation package when the upgrade signature installation package is verified successfully, therefore the signature application is upgraded from the first version to the second version.

In one embodiment, the service platform pre-stores a current installation package and the current signature information, which correspond to the second version of the signature application. The current signature information is configured to verify the second version of the signature application. When the current installation package is configured to install the second version of the signature application while the current signature information has verified the second version of the signature application successfully. The terminal device has installed with the first version of the signature application. The first version is lower than the second version, which represents that the second version is a to-be-upgraded version of the signature application.

While it is determined that the installation instruction is the upgrade installation instructions, the differential package and the current signature information, which correspond to the second version of the signature application, are transmitted to the terminal device. The terminal device receives and responses to the differential package and the current signature information for obtaining an original signature installation package of the installed first version of the signature application, analyzing original signature installation package to obtain the original installation package and original signature information, deleting the original signature information, compositing the original installation package and the differential package to obtain upgrade installation package, performing a package assembly on the upgrade installation package and the current signature information to obtain the upgrade signature installation package, determining whether the upgrade signature installation package is verified successfully according to the current signature information, upgrading and installing the signature application according to the upgrade signature installation package while the upgrade signature installation package is verified successfully, therefor the signature application is upgraded from the first version to the second version, this implements the generation of the upgrade signature installation package according to the original installation package obtained by restoring the original signature package corresponding to the first version, the differential package corresponding to the second version, and the current signature information corresponding to the second version, while it is determined the installation instruction is the upgrade installation instruction, and the signature application is upgraded and installed from the first version into the second version according to the upgrade signature installation package while the upgrade signature installation package is verified successfully, there is no need to delete the original signature information manually by the users, an efficiency of the installation of upgrading of the signature application is improved.

The differential package is a difference data package between the current installation package corresponding to the second version of the signature application and the original installation package corresponding to the first version of the signature application installed in the terminal device.

The solution provided by the present embodiment, the installation instruction of the signature application is obtained, while the installation instruction is the upgrade installation instruction, the differential package and the current signature information, which correspond to the second version of the signature application, are transmitted to the terminal device, which cause the terminal device to generate the corresponding upgrade signature installation package according to the original installation package, the differential package, and the current signature information, to upgrade and install the signature application according to the upgrade signature installation package while the upgrade signature installation package is verified successfully, therefore, the signature application is upgraded from the first version to the second version. This implements the generation of the upgrade signature installation package according to the original installation package obtained by restoring the original signature package corresponding to the first version, the differential package corresponding to the second version, and the current signature information corresponding to the second version while it is determined the installation instruction is the upgrade installation instruction. The signature application is upgraded and installed from the first version into the second version according to the upgrade signature installation package while the upgrade signature installation package is verified successfully. There is no need to delete the original signature information manually by the users, the efficiency of the installation of upgrading of the signature application is improved.

Referring to FIG. 4, FIG. 4 shows an embodiment of an upgrade installation apparatus 300 provided by the present application. The upgrade installation apparatus 300 may be applied in the terminal device 100 of the upgrade installation system as shown in FIG. 1, the following describes the upgrade installation apparatus 300 of FIG. 4 in detail by using the terminal device 100 as an example. The upgrade installation apparatus 300 may include a first instruction obtaining module 310, an upgrade download request transmitting module 320, an installation package obtaining module 330, a restoring module 340, an upgrade installation package generating module 350, and an upgrade installation module 360.

The first instruction obtaining module 310 may be configured to obtain an installation instruction of the signature application; the upgrade download request transmitting module 320 may be configured to transmit an upgrade download request to the service platform while it is determined that the installation instruction is the upgrade installation instruction, which causes the service platform to transmit a differential package and the current signature information, which correspond to a second version of the signature application, to the terminal device based on the upgrade download request, the differential package is a difference data package between a current installation package corresponding to the second version of the signature application and an original installation package corresponding to the first version of the signature application installed in the terminal device, the first version is lower than the second version; the installation package obtaining module 330 may be configured to obtain an original signature installation package of the first version of the signature application, the original signature installation package may include original signature information and the original installation package, the restoring module 340 may be configured to restore the original signature installation package to obtain the original installation package; the upgrade installation package generating module 350 may be configured to generate an upgrade signature installation package according to the original installation package, the differential package, and the current signature information; the upgrade installation module 360 may be configured to upgrade and install the signature application according to the upgrade signature installation package while the upgrade signature installation package is verified successfully, therefore the signature application is upgraded from the first version to the second version.

In some embodiments, the upgrade installation apparatus 300 also may include an identifier obtaining module and a first determining module.

The identifier obtaining module may be configured to obtain a first application identifier set of the applications installed in the terminal device before transmitting the upgrade download request to the service platform while the upgrade download request transmitting module 320 determines that the installation instruction is the upgrade installation instruction, which causes the service platform to transmit a differential package and the current signature information, which correspond to a second version of the signature application, to the terminal device based on the upgrade download request. The first determining module may be configured to determine whether the installation instruction is the upgrade installation instruction according to a second application identifier and the first application identifier set.

In some embodiments, the upgrade download request transmitting module 320 may include a transmitting unit.

The transmitting unit may be configured to determine the installation instruction is the upgrade installation instruction and transmit the upgrade download request to the service platform while the second application identifier is included in the first application identifier set, which causes the service platform to transmit a differential package and the current signature information, which correspond to a second version of the signature application, to the terminal device based on the upgrade download request.

In some embodiments, the upgrade installation apparatus 300 also may include a second determining module, a complete download request transmitting module, a complete installation package generating module, and a complete installing module.

The second determining module may be configured to determine the installation instruction is a non-upgrade installation instruction while the second application identifier is not included in the first application identifier set; the complete download request transmitting module may be configured to transmit a complete download request to the service platform, which cause the service platform to transmit the current installation package and the current signature information to the terminal device according to the complete download request; the complete installation package generating module may be configured to generate a corresponding complete signature package according to the current installation package and the current signature information; the complete installing module may be configured to install the second version of the signature application according to the complete installation package while the complete signature installation package is verified successfully.

In some embodiments, the restoring module 340 may include an analyzing unit and a deleting unit.

The analyzing unit may be configured to analysis the original signature installation package to obtain the original installation package and the original signature information; the deleting unit may be configured to delete the original signature information.

The solution provided by the embodiment, the installation instruction of the signature application is obtained, while the installation instruction is the upgrade installation instruction, the upgrade download request is transmitted to the service platform, which causes the service platform to transmit the differential package and the current signature information, which correspond to the second version of the signature application, to the terminal device according to the upgrade download request. The differential package is the difference data package between the current installation package corresponding to the second version of the signature application and the original installation package corresponding to the first version of the signature application installed in the terminal device. The first version is lower than the second version. The original signature installation package of the first version of the signature application is obtained. The original signature installation package includes the original signature information and the original signature installation package. The original signature installation package is restored to obtain the original installation package. The corresponding upgrade signature installation package is generated based on the original installation package, the differential package, and current signature information. When it is determined that the upgrade signature installation package is verified successfully, the signature application is upgraded and installed according to the upgrade signature installation package, thus the signature application is upgraded from the first version to the second version. This implements the generation of the upgrade signature installation package according to the original installation package obtained by restoring the original signature package corresponding to the first version, the differential package corresponding to the second version, and the current signature information corresponding to the second version while it is determined the installation instruction is the upgrade installation instruction. The signature application is upgraded and installed from the first version into the second version according to the upgrade signature installation package while the upgrade signature installation package is verified successfully. There is no need to delete the original signature information manually by the users, an efficiency of the installation of upgrading of the signature application is improved.

Referring to FIG. 5, FIG. 5 shows another embodiment of an upgrade installation apparatus 400 provided by the present application. The upgrade installation apparatus 400 may be applied in the service platform 200 of the upgrade installation system as shown in FIG. 1, the following describes the upgrade installation apparatus 400 of FIG. 5 in detail by using the service platform 200 as an example. The upgrade installation apparatus 400 may include a second instruction obtaining module 410 and an information transmitting module 420.

The second instruction obtaining module 410 may be configured to obtain the installation instruction of the signature application; the information transmitting module 420 may be configured to transmit the differential package and the current signature information, which correspond to the second version of the signature application, to the terminal device while the installation instruction is the upgrade installation instruction, which causes the terminal device to generate a corresponding upgrade signature installation package according to an original installation package, the differential package, and the current signature information, to upgrade and install the signature application according to the upgrade signature installation package when the upgrade signature installation package is verified successfully, the signature application is upgraded from the first version to the second version. The original installation package is obtained by restoring the original signature package of the first version of the signature application installed in the terminal device through the terminal device. The original signature installation package includes original installation package and the original signature information, the first version is lower than the second version. The differential package is a difference data package between the current installation package corresponding to the second version of the signature application and the original installation package.

The solution provided by the present embodiment, the installation instruction of the signature application is obtained, while the installation instruction is the upgrade installation instruction, the differential package corresponding to the second version of the signature application and the current signature information corresponding to the second version of the signature application are transmitted to the terminal device, which cause the terminal device to generate the corresponding upgrade signature installation package according to the original installation package, the differential package, and the current signature information, to upgrade and install the signature application according to the upgrade signature installation package while the upgrade signature installation package is verified successfully, therefore, the signature application is upgraded from the first version to the second version. This implements the generation of the upgrade signature installation package according to the original installation package obtained by restoring the original signature package corresponding to the first version, the differential package corresponding to the second version, and the current signature information corresponding to the second version while it is determined the installation instruction is the upgrade installation instruction. The signature application is upgraded and installed from the first version into the second version according to the upgrade signature installation package while the upgrade signature installation package is verified successfully. There is no need to delete the original signature information manually by the users, the efficiency of the installation of upgrade of the signature application is improved.

It should be noted that, embodiments in this application are all described in a progressive manner, for same or similar parts in embodiments, refer to these embodiments, and each embodiments focuses on a difference from other embodiments. As for the device-type embodiments, because they are basically similar to the method embodiments, the description thereof is relatively simple. For details of related parts, reference can be made to the description of the method embodiments. Any processing method described in the method embodiments can be implemented by corresponding processing modules in the device embodiments, and will not be described one by one in the device embodiments.

In addition, functional modules in embodiments of this application may be integrated into one processing module, or each of the modules may exist along physically, or two or more modules are integrated into one module. The integrated module may be implemented either in the form of hardware or a software functional module.

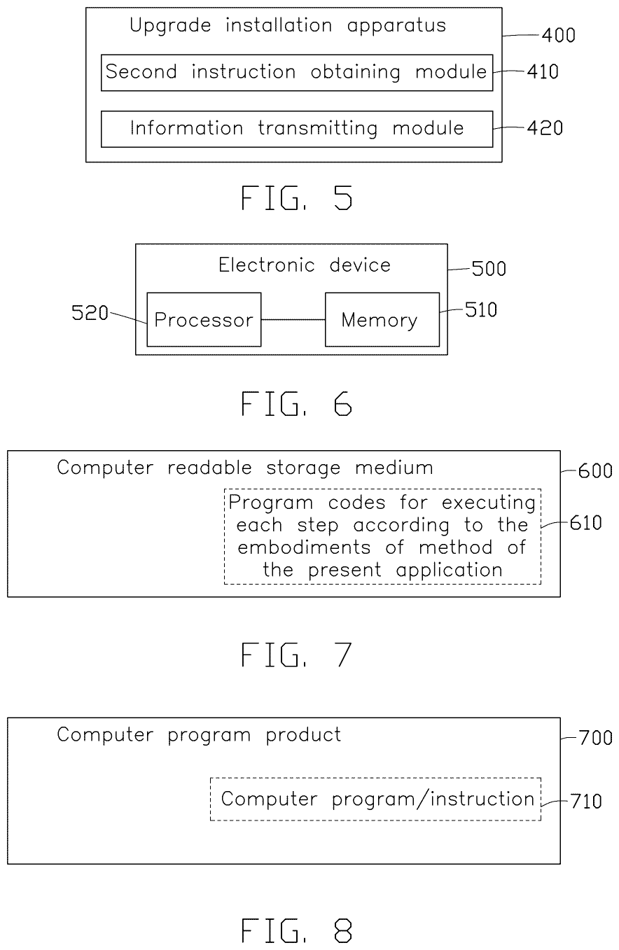

Referring to FIG. 6, FIG. 6 shows a function block diagram of an embodiment of an electronic device 500 according to the present application. The electronic device 500 may include one ore more following components: a memory 510, a processor 520, and one or more application programs. The one or more application programs may be stored in the memory 510 and be configured to be executed by the one or more processor 520, the one or more application programs may be configured to execute the method described as the foregoing embodiments.

The memory 510 may include a Random Access Memory (RAM), or may include a Read-Only memory. The memory 510 may be configured to store instructions, programs, code, code sets, or instruction sets. The memory 510 may include a storge program area and a storge data area, where the storage program area may store instructions for implementing at least one function (such as an obtaining installation instruction, an instruction of determining the installation instruction to be the upgrade installation instruction, an instruction of obtaining original signature installation package, an instruction of restoring original signature installation package, an instruction of obtaining original installation package, an instruction of transmitting an upgrade download request, an instruction of transmitting differential package, an instruction of transmitting current signature information, an instruction of generating upgrade signature installation package, an instruction of verifying the upgrade signature installation package successfully, an instruction of upgrading and installing, an instruction of obtaining a first application identifier set, an instruction of determining whether it is the upgrade installation instruction, an instruction of the installation instruction to be a non-upgrade installation instruction, an instruction of transmitting a complete download request, an instruction of transmitting a current installation package, an instruction of generating a complete signature installation package, an instruction of verifying the complete signature installation package successfully, an instruction of installing the second version of the signature application, an instruction of analyzing the original signature installation package, an instruction of obtaining the original installation package, an instruction of obtaining original signature information, and an instruction of deleting the original signature information, and so on), instructions for implementing each of the method embodiments described above, and so on. The storage data area may store data (such as the terminal device, the signature application, the installation instruction, the upgrade installing instruction, the first version, the original signature installation package, the original signature information, the upgrade download request, the service platform, the second version, the first version being lower than the first version, the current installation package, the difference data package, the upgrade signature installation package, the first application identifier set, the second application identifier included in the first application identifier set, the second application identifier being not-included in the first application identifier set, the non-upgrade installation instruction, the complete download request, and a complete signature installation package) created based on the uses of the electronic device 500, and so on.

The processor 520 may include one or more processing cores. The processor 520 connects various parts of entire electronic device 500 by using various interfaces and lines. By running or executing instructions, a program, a code set, or an instruction set stored in the memory 510 and invoking data stored in the memory 510, the processor 520 executes various functions of the electronic device 500 and processes data. Optionally, the processor 520 may be implemented by using at least one hardware form of a digital signal processor (DSP), a field-programmable gate array (FPGA), and a programmable logic array (PLA). The processor 520 may integrate one or a combination of a central processing unit (CPU), a graphics processing unit (GPU), a modem, and the like. The CPU mainly process an operating system, a user interface, an application program, and the like. The GPU is configured to be responsible for rendering and drawing content. The modem is mainly configured to process wireless communication. It may be understood that the modem may not be integrated into the processor 510, and is implemented by using a communication chip separately.

Referring to FIG. 7, FIG. 7 shows an embodiment of a structural block diagram of a computer readable storage medium according to the present application. The computer readable storage medium 600 stores program code 610, the program code 610 may be invoked by the processor to execute the method of the foregoing embodiments.

The computer readable storage medium 600 may be an electronic memory, such as a flash memory, an electrically erasable programmable read-only memory (EEPROM), an EPROM, a hard disk, or a read only memory (ROM). Optionally, the computer readable storage medium 600 includes a non-transitory computer-readable storage medium. The computer readable storage medium 600 has storage space of program code that is used to execute any method step in the foregoing methods. The program code may be compressed in an appropriate form.

Referring to FIG. 8, FIG. 8 shows an embodiment of a structural block diagram of a computer program product 700 according to the present application. The computer program product 700 includes computer programs/instructions 710. The computer programs/instructions 710 stores in a computer readable storage medium of a computer device. When the computer program product 700 is run in the computer device, a processor of the computer device reads the computer programs/instructions 710 from the computer readable storage medium, the processor executes the computer programs/instructions 710, thus the computer device is enable to perform the method described in the foregoing embodiments.

The solution provided by the present embodiment, the installation instruction of the signature application is obtained, while the installation instruction is the upgrade installation instruction, the upgrade download request is transmitted to the service platform, which causes the service platform to transmit the differential package and the current signature information, which correspond to the second version of the signature application, to the terminal device according to the upgrade download request. The differential package is the difference data package between the current installation package corresponding to the second version of the signature application and the original installation package corresponding to the first version of the signature application installed in the terminal device. The first version is lower than the second version. The original signature installation package of the first version of the signature application is obtained. The original signature installation package includes the original signature information and the original signature installation package. The original signature installation package is restored to obtain the original installation package. The corresponding upgrade signature installation package is generated based on the original installation package, the differential package, and current signature information. When it is determined that the upgrade signature installation package is verified successfully, the signature application is upgraded and installed according to the upgrade signature installation package, thus the signature application is upgraded from the first version to the second version. This implements the generation of the upgrade signature installation package according to the original installation package obtained by restoring the original signature package corresponding to the first version, the differential package corresponding to the second version, and the current signature information corresponding to the second version while it is determined the installation instruction is the upgrade installation instruction. The signature application is upgraded and installed from the first version into the second version according to the upgrade signature installation package while the upgrade signature installation package is verified successfully. There is no need to delete the original signature information manually by the users, an efficiency of the installation of upgrading of the signature application is improved.

Finally, it should be noted that the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the sprit and scope of the technical solutions of the embodiments of this application.

1. An upgrade installation method, applied in a terminal device; the upgrade installation method comprises:
obtaining an installation instruction of a signature application;
when it is determined that the installation instruction is an upgrade installation instruction, transmitting an upgrade download request to a service platform, which causes the service platform to transmit a differential package and current signature information, which correspond to a second version of the signature application, to the terminal device based on the upgrade download request; the differential package is a difference data package between a current installation package corresponding to the second version of the signature application and an original installation package corresponding to a first version of the signature application installed in the terminal device; the first version is lower than the second version;
obtaining an original signature installation package of the first version of the signature application, the original signature installation package comprises original signature information and the original installation package;
restoring the original signature installation package to obtain the original installation package;
generating a corresponding upgrade signature installation package based on the original installation package, the differential package, and current signature information;
when it is determined that the upgrade signature installation package is verified successfully, upgrading and installing the signature application according to the upgrade signature installation package, which cause the signature application to be upgraded from the first version to the second version.

2. The upgrade installation method according to claim 1, before when it is determined that the installation instruction is an upgrade installation instruction, transmitting an upgrade download request to a service platform, which causes the service platform to transmit a differential package and the current signature information, which correspond to a second version of the signature application, to the terminal device based on the upgrade download request, the upgrade installation method further comprises:
obtaining a first application identifier set corresponding to applications installed in the terminal device;
wherein when it is determined that the installation instruction is the upgrade installation instruction, transmitting the upgrade download request to the service platform, which causes the service platform to transmit the differential package and the current signature information, which correspond to the second version of the signature application, to the terminal device based on the upgrade download request comprises:
when it is determined that a second identifier of the signature application is included in the first application identifier set, it is determined that the installation instruction is the upgrade installation instruction, transmitting the upgrade download request to the service platform, which cause the service platform to transmit the differential package and the current signature information, which correspond to the second version of the signature application, to the terminal device based on the upgrade download request.

3. The upgrade installation method according to claim 2, the upgrade installation method further comprises:
when the second identifier of the signature application is not included in the first application identifier set, it is determined that the installation instruction is the non-upgrade installation instruction;
transmitting a complete download request to the service platform, which cause the service platform to transmit a current installation package and the current signature information to the terminal device according to the complete download request;
generating a complete signature installation package according to the current installation package and the current signature information; and
when the complete signature installation package is verified successfully, installing the second version of the signature application according to the complete signature installation package.

4. The upgrade installation method according to claim 1, the restoring the original signature installation package to obtain the original installation package comprises:
analysis the original signature installation package to obtain the original installation package and the original signature information; and
deleting the original signature information.

5. An upgrade installation method, applied in a terminal device; the upgrade installation method comprises:
obtaining an installation instruction of a signature application; and
transmitting a differential package and current signature information, which correspond to a second version of the signature application, to a terminal device, which cause the terminal device to generate a corresponding upgrade signature installation package according to an original installation package, the differential package, and the current signature information, when it is determined that the installation instruction is an upgrading installation instruction, and to upgrade and install the signature application according to the upgrade signature installation package, which cause the signature application to be upgraded from a first version to the second version, when it is determined that the upgrade signature installation package is verified successfully; wherein the original installation package is obtained by using the terminal device to restore a original signature installation package of the first version of the signature application installed in the terminal device; the original signature installation package comprises original installation package and original signature information, the first version is lower than the second version, the differential package is a difference data package between a current installation package corresponding to the second version of the signature application and the original installation package.

6. A computer readable storage medium used in terminal device, the computer readable storage medium stores computer codes, the program codes are invoked by a processor to execute the following steps:
obtaining an installation instruction of a signature application;
when it is determined that the installation instruction is an upgrade installation instruction, transmitting an upgrade download request to a service platform, which causes the service platform to transmit a differential package and current signature information, which correspond to a second version of the signature application, to the terminal device based on the upgrade download request; the differential package is a difference data package between a current installation package corresponding to the second version of the signature application and an original installation package corresponding to a first version of the signature application installed in the terminal device; the first version is lower than the second version;
obtaining an original signature installation package of the first version of the signature application, the original signature installation package comprises original signature information and the original installation package:
restoring the original signature installation package to obtain the original installation package;
generating a corresponding upgrade signature installation package based on the original installation package, the differential package, and current signature information;
when it is determined that the upgrade signature installation package is verified successfully, upgrading and installing the signature application according to the upgrade signature installation package, which cause the signature application to be upgraded from the first version to the second version.

6. The computer readable storage medium according to claim 6, wherein before when it is determined that the installation instruction is an upgrade installation instruction, transmitting an upgrade download request to a service platform, which causes the service platform to transmit a differential package and the current signature information, which correspond to a second version of the signature application, to the terminal device based on the upgrade download request, the upgrade installation method further comprises:
obtaining a first application identifier set corresponding to applications installed in the terminal device;
wherein when it is determined that the installation instruction is the upgrade installation instruction, transmitting the upgrade download request to the service platform, which causes the service platform to transmit the differential package and the current signature information, which correspond to the second version of the signature application, to the terminal device based on the upgrade download request comprises:
when it is determined that a second identifier of the signature application is included in the first application identifier set, it is determined that the installation instruction is the upgrade installation instruction, transmitting the upgrade download request to the service platform, which cause the service platform to transmit the differential package and the current signature information, which correspond to the second version of the signature application, to the terminal device based on the upgrade download request.

8. The computer readable storage medium according to claim 7, wherein the method further comprises:
when the second identifier of the signature application is not included in the first application identifier set, it is determined that the installation instruction is the non-upgrade installation instruction;
transmitting a complete download request to the service platform, which cause the service platform to transmit a current installation package and the current signature information to the terminal device according to the complete download request;
generating a complete signature installation package according to the current installation package and the current signature information; and
when the complete signature installation package is verified successfully, installing the second version of the signature application according to the complete signature installation package.

9. The computer readable storage medium according to claim 6, wherein the restoring the original signature installation package to obtain the original installation package comprises:
analysis the original signature installation package to obtain the original package and the original signature information; and
deleting the original signature information.

10. The computer readable storage medium according to claim 7, wherein the terminal device transmits the upgrade download request to the service platform through a predefined application program interface (API).

11. The computer readable storage medium according to claim 6, wherein the terminal device comprises a local memory; the local storage stores the original signature installation package of the first version of the signature application installed in the terminal device; the terminal device reads the original signature installation package of the installed first version of the signature application from the local memory.

12. The computer readable storage medium according to claim 6, wherein while an installation instruction of the signature application is inputted by the terminal device, the installation instruction of the signature application is determined to be detected.

13. The computer readable storage medium according to claim 6, wherein terminal device is set with a voice identification module; while voice information in a voice collection range of the voice identification module requires the signature application to be installed, the voice identification module collects the voice, and executes a voice identification of the collected voice; when identifying the key words, which indicates an installation of the signature application, in an identification result of the voice identification.
